(19) United States
(12) Patent Application Publication
(10) Pub. No.: US 2025/0318606 A1
(43) Pub. Date: Oct. 16, 2025

(54) FASTENER TAPE AND SLIDE FASTENER

(71) Applicants: YKK CORPORATION, Chiyoda-ku, Tokyo (JP); DAINICHISEIKA COLOR & CHEMICALS MFG. CO., LTD., Chuo-ku, Tokyo (JP)

(72) Inventors: Takayuki OGYU, Kurobe-shi, Toyama (JP); Tomoya KOSAKA, Kurobe-shi, Toyama (JP); Mitsuaki NEGISHI, Kurobe-shi, Toyama (JP); Shinya ITAI, Kurobe-shi, Toyama (JP); Kanna OKUIZUMI, Chuo-ku, Tokyo (JP); Toru OURA, Chuo-ku, Tokyo (JP); Kazuya SASAKI, Chuo-ku, Tokyo (JP)

(21) Appl. No.: 18/564,034

(22) PCT Filed: Jun. 2, 2021
(86) PCT No.: PCT/JP2021/021081

§ 371 Date: Feb. 25, 2025

(51) Int. Cl. A44B 19/32; B32B 5/02; B32B 27/12; B32B 27/40

(52) U.S. Cl. CPC A44B 19/32; B32B 5/024; B32B 27/12; B32B 27/40; B32B 2307/7265

(57) ABSTRACT

The present invention is related to a fastener tape (10) including a base fabric (11) having a first surface (10a) and a second surface (11b), and a water-stop film (12) attached to at least one of the first surface (10a) and the second surface (11b) of the base fabric (11). The water-stop film (12) has a laminated structure consisting of a skin layer (14) consisting of a polyurethane film, and an adhesive layer (13) made of a cured polyurethane adhesive provided between the skin layer (14) and the base fabric (11). The polyurethane adhesive is derived from a polyurethane resin dissolved in a solvent containing dimethyl carbonate and propyl acetate. A slide fastener (1) according to the present invention includes the fastener tape (10).

### FIELD OF THE INVENTION

The present invention relates to a fastener tape and a slide fastener, and more particularly to a water-stop fastener tape and a slide fastener equipped with such a fastener tape.

### BACKGROUND OF THE INVENTION

Slide fasteners are used for clothing, bags, shoes, tents, covers for shipping containers, and the like. A slide fastener includes a pair of left and right fastener tapes, an element row for example sewn along opposing edges of each of the fastener tapes, and a slider for engaging and separating the left and right element rows. In order to impart water-stop properties to slide fasteners, a skin layer having water-stop properties is provided on the base fabric of the fastener tape via an adhesive.

In recent years, there has been a growing demand for products to be made that take into consideration the environmental impact caused by the organic solvents contained in the adhesives used in the manufacture of slide fasteners and the health of workers. In particular, international standards regarding textile products are becoming stricter year by year, and toluene and methyl ethyl ketone (MEK), which are contained in adhesive solvents, are also subject to regulations. Therefore, there is a demand for an eco-friendly water-stopping slide fastener that eliminates toluene and MEK as much as possible.

Japanese Patent No. 5981547 (Patent Literature 1) discloses a technique for imparting water-stop properties to a slide fastener using an aqueous solvent that does not contain toluene or MEK as an adhesive. However, it is necessary to overcome another technical problem that aqueous solvents have weak dissolving power. If the solvent's dissolving power is weak, the resin components contained in the adhesive will be poorly dispersed, and as a result, it is necessary to improve the resin components contained in the adhesive so that they are easily soluble in water-based solvents. Otherwise, bubbles or cracks will occur in the adhesive layer, the appearance and texture of the fastener tape will deteriorate, and the softness of the fastener tape will be impaired.

### PRIOR ART

### Patent Literature

[Patent Literature 1] Japanese Patent No. 5981547

### SUMMARY OF THE INVENTION

The present invention has been made in view of the above problems, and the object of the present invention is to provide a fastener tape that uses an organic solvent that does not contain toluene or MEK as an adhesive and can provide water-stopping properties to slide fasteners, and to provide a slide fastener using such a fastener tape.

According to one aspect of the present invention, there is provided a fastener tape comprising a base fabric having a first surface and a second surface, and a water-stop film attached to at least one of the first surface and the second surface of the base fabric, the fastener tape characterized in that the water-stop film has a laminated structure consisting of a skin layer made of a polyurethane film and an adhesive layer made of a cured product of a polyurethane adhesive provided between the skin layer and the base fabric; and the polyurethane adhesive is a polyurethane resin dissolved in a solvent containing dimethyl carbonate and propyl acetate.

According to another aspect of the present invention, there is provided a fastener tape comprising a base fabric having a first surface and a second surface, and a water-stop film attached to at least one of the first surface and the second surface of the base fabric, the fastener tape characterized in that the water-stop film has a laminated structure consisting of a skin layer made of a polyurethane film, and an adhesive layer made of a cured product of a polyurethane adhesive provided between the skin layer and the base fabric; and the polyurethane adhesive is made by dissolving polyurethane resin in a solvent containing dimethyl carbonate, propyl acetate, and butyl acetate.

In one embodiment of the invention, the polyurethane adhesive does not contain toluene and methyl ethyl ketone.

In one embodiment of the invention, the solvent comprises 24 to 28% by weight of dimethyl carbonate, 59 to 63% by weight of propyl acetate, and 11 to 15% by weight of butyl acetate.

In one embodiment of the invention, the solvent evaporates at 90° C. to 110° C.

According to another aspect of the present invention, there is provided a slide fastener comprising the above-described fastener tape.

According to the present invention, as a solvent for the adhesive layer to attach a skin layer of a water-stop film to the base fabric of a fastener tape, by using one containing dimethyl carbonate (DMC) and propyl acetate or one containing DMC, propyl acetate and butyl acetate, it is possible to provide water-stopping properties to slide fasteners while maintaining their dissolving power, even without toluene or MEK.

### BRIEF DESCRIPTION OF THE DRAWINGS

FIG. 1 is a bottom view of a slide fastener according to an embodiment of the present invention.

FIG. 2 is an explanatory cross-sectional view showing a cross-section of the fastener tape along line A-A in FIG. 1, exaggerated for convenience.

### DETAILED DESCRIPTION OF THE INVENTION

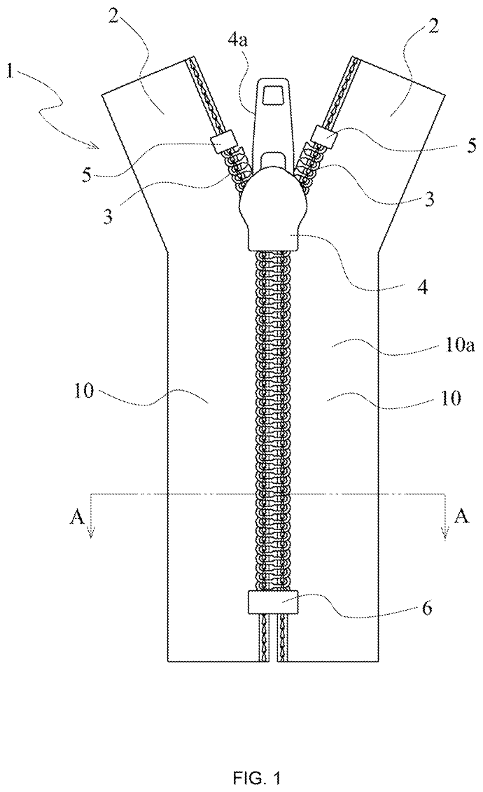

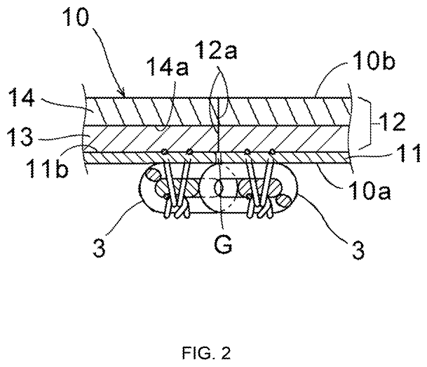

FIG. 1 is a bottom view showing a slide fastener 1 according to an embodiment of the present invention. The slide fastener 1 includes a pair of left and right fastener stringers 2, 2, and a slider 4 for opening and closing between the left and right fastener stringers 2, 2. Each fastener stringer 2 includes a linear fastener tape 10 and an element row 3 provided along opposite side edges of each fastener tape 10 in the width direction. In the bottom view of FIG. 1, the back surface 10a of the fastener tape 10 is shown. A handle 4a connected to the slider 4 is arranged on the surface 10b (see FIG. 2) side of the fastener tape 10. The left and right element rows 3 are brought into engagement by moving the slider 4 toward one side (upward in the plane of FIG. 1), and are disengaged by moving the slider 4 toward the other side (downward in the plane of FIG. 1). The slide fastener 1 is further provided with an upper stopper 5 and a lower stopper 6 that restrict movement of the slider 4 to one side and the other side. In this embodiment, the element row 3 is a coil-shaped monofilament wound spirally, and is attached to the opposite side edge of the back surface 10a of each fastener tape 10 with a sewing thread. However, the element row 3 is not limited to this, and can be provided on the surface 10b of the fastener tape 10 (see FIG. 2). Further, a large number of elements made of metal or synthetic resin can be provided by crimping or injection molding on opposing side edges extending over both the front and back surfaces 10a and 10b of the fastener tape 10.

FIG. 2 is an explanatory cross-sectional view showing a cross section of the fastener tape 10 along line A-A in FIG. 1, exaggerated for convenience. In FIG. 2, the left and right element rows 3 are in an engaged state. The fastener tape 10 has a back surface 10a to which the element row 3 is attached, and a surface 10b opposite to the back surface 10a. In FIG. 2, the back surface 10a of the fastener tape 10 faces downward, and the surface 10b faces upward. Hereinafter, in the description of the fastener tape 10 with reference to FIG. 2, the upper and lower configurations are based on the plane of FIG. 2. The fastener tape 10 is composed of a base fabric 11 and a water-stop film 12 attached to the upper surface (second surface) 11b of the base fabric 11. The lower surface (first surface) of the base fabric 11 is the back surface 10a of the fastener tape 10. The water-stop film 12 has a laminated structure consisting of a lower adhesive layer 13 and an upper skin layer 14. It can also be said that the adhesive layer 13 is provided between the base fabric 11 and the skin layer 14. The upper surface of the skin layer 14 becomes the surface 10b of the fastener tape 10. Referring to FIG. 2, a slight gap G is created between the left and right base fabrics 11 when the left and right element rows 3 are in an engaged state. On the other hand, such a gap G is minimized between the left and right water-stop films 12 on the base fabric 11, and the opposing end surfaces 12a of the left and right water-stop films 12 are configured in close contact with each other. This increases the water-stopping properties of the slide fastener 1. In this embodiment, the water-stop film 12 is attached only to the upper surface 11b of the base fabric 11, but it can be attached only to the lower surface 10a of the base fabric 11, or to both the upper surface 11b and the lower surface 10a of the base fabric 11.

### Base Fabric 11

The material of the base fabric 11 may be natural fibers or synthetic fibers commonly used for the fastener tape 10. Although there are no particular limitations, examples include polyamide fibers, polyester fibers, acrylic fibers, and the like. The base fabric 11 can be produced by weaving or knitting these synthetic fibers. Typically, it can be woven or knitted with polyester fibers.

### Adhesive Layer 13

The adhesive layer 13 is composed of a main ingredient which is an adhesive component and a solvent for dissolving the main ingredient. The main ingredient is composed of a cured product of polyurethane adhesive, preferably a three-dimensionally crosslinked cured product. The polyurethane adhesive preferably contains polyurethane, an isocyanate compound as a hardening agent, and a solvent as a diluent. It is also possible to add thickeners to adjust the viscosity. Polyurethanes are typically in particulate form, and for example, are provided in the form of polyurethane emulsions or polyurethane dispersions.

According to one embodiment of the invention, the solvent for adhesive layer 13 includes dimethyl carbonate (DMC) and propyl acetate. According to another embodiment of the invention, the solvent of adhesive layer 13 comprises dimethyl carbonate (DMC), propyl acetate and butyl acetate. As the composition of the solvent, for example, when dimethyl carbonate (DMC) and propyl acetate are contained, it may comprise 30% to 40% by weight of DMC and 60% to 70% by weight of propyl acetate. When the solvent contains dimethyl carbonate (DMC), propyl acetate and butyl acetate, it may comprise 24 to 28% by weight of DMC, 59 to 63% by weight of propyl acetate, and 11 to 15% by weight of butyl acetate, and in particular, it is most preferable to comprise 26% by weight of dimethyl carbonate, 61% by weight of propyl acetate, and 13% by weight of butyl acetate.

Further, in this embodiment, the solvent does not include toluene and MEK. As mentioned above, toluene and MEK are subject to environmental regulations, and their amounts need to be strictly controlled. By utilizing DMC, propyl acetate, and butyl acetate, the solvent of this embodiment has good dissolving power for polyurethane, which is an adhesive component, even without the use of toluene and MEK. It is possible to suppress the occurrence of bubbles or cracks in the adhesive layer 13, deterioration of the appearance and texture of the fastener tape 10, and loss of softness of the fastener tape 10.

Further, the solvent is preferably one that vaporizes at 90 to 110° C. If the solvent evaporates at 90 to 110° C., the solvent will evaporate during the production of the fastener tape 10 by heating and pressurizing, leaving only the viscous components such as polyurethane, so that clouding of the fastener tape 10 and generation of air bubbles can be suppressed.

Isocyanate compounds used as curing agents can contain aliphatic isocyanates, cycloaliphatic isocyanates, aromatic isocyanates, or combinations thereof. Isocyanates can be selected, for example, from dimers, trimers, isocyanate derivatives, isocyanate prepolymers, blocked isocyanates. Since aromatic isocyanates tend to yellow, aliphatic isocyanates, alicyclic isocyanates, or a combination thereof, which have excellent color fastness, have long pot life (the time it takes for adhesives to lose their viscosity and condition after being mixed with hardeners, catalysts, and the like), so they are preferable. As aliphatic isocyanates, for example, mention can be made to ethylene diisocyanate, tetramethylene diisocyanate, hexamethylene diisocyanate, dodecamethylene diisocyanate, 2,2,4-trimethylhexane diisocyanate, lysine diisocyanate, 2,6-diisocyanatomethyl caproate, isophorone diisocyanate, 1,4-cyclohexane diisocyanate, 4,4′-dicyclohexylmethane diisocyanate, bis(isocyanatomethyl)cyclohexane, cyclohexylene diisocyanate, and methylcyclohexylene diisocyanate.

The thickness of the adhesive layer 13 is preferably 0.02 mm or more, since if it is too thin, the texture will be impaired. On the other hand, the thickness of the adhesive layer 13 is preferably 0.2 mm or less because if it is too thick, the slider 4 will come into sliding contact when the slide fastener 1 is opened and closed, impairing sliding properties.

### Skin Layer 14

The skin layer 14 can be formed of an organic solvent-based polyurethane film, but is not limited thereto. Here, “organic solvent-based” means that an organic solvent is used as a dispersant. An organic solvent-based polyurethane film can be obtained by drying a solution in which polyurethane is dissolved in an organic solvent. In addition, for organic solvent-based polyurethane, a curing agent may be added to a solution in which polyurethane is dissolved in an organic solvent to undergo a curing reaction. By adding a curing agent, the strength of the film can be improved. Isocyanate compounds can be suitably used as the curing agent.

Any polyurethane known to those skilled in the art can be used as the polyurethane, and examples include polyether polyurethane, polyester polyurethane, polycarbonate polyurethane, and polycaprolactone polyurethane. Among these, polycarbonate polyurethane is preferred because of the strength of the film itself.

The skin layer 14 preferably contains a silicone compound in order to prevent the skin layer 14 from being damaged by sliding with the slider 4. In order to effectively exhibit durability against sliding, it is preferable that the silicone compound comprises 2% by weight or more, more preferably 4% by weight or more of the skin layer 14 (in terms of solid content). However, if the content of the silicone compound becomes too large, the skin layer 14 may become brittle, so it is preferable that the silicone compound comprises 25% by weight or less in the skin layer 14, and it is more preferable that the silicone compound comprises 15% by weight or less. It is desirable that at least a portion of the silicone compound exist in a copolymerized form with the polyurethane constituting the skin layer 14 in order to improve the abrasion resistance (durability for reciprocating opening and closing of the fastener).

An example of a procedure for attaching the water-stop film 12 to the base fabric 11 will be described. A cured product of the skin layer 14 is prepared, and the adhesive layer 13 is applied to the lower surface 14a and dried. Next, the adhesive layer 13 of the water stop film 12 is bonded to the back surface 11b of the base fabric 11, and the water-stop film 12 is bonded to the base fabric 11 by heating and pressing. Next, the curing agent is cured by carrying out a curing acceleration reaction, for example, at a curing temperature of 40 to 60° C. for 48 hours or more. Thereby, the water-stop film 12 is firmly attached onto the base fabric 11. The water-stop film 12 can also be attached to the base fabric 11 by applying the adhesive layer 13 to the base fabric 11 side.

### EXAMPLES

In Table 1, the following characteristics are compared for solvent 1 (26% by weight of dimethyl carbonate, 61% by weight of propyl acetate, and 13% by weight of butyl acetate) used for the adhesive layer 13 in the fastener tape 10 of the slide fastener 1 described above; Solvent 2 containing conventional toluene and MEK (70% by weight toluene and 30% by weight MEK); Solvents 3 to 6 as further Examples; and Solvents 7 and 8 as Comparative Examples.
Solvent 3: 30% by weight of DMC, and 70% by weight of propyl acetate
Solvent 4: 26% by weight of DMC, 66% by weight of propyl acetate, and 8% by weight of butyl acetate
Solvent 5: 31% by weight of DMC, 61% by weight of propyl acetate, and 8% by weight of butyl acetate
Solvent 6: 26% by weight of DMC, 61% by weight of propyl acetate, and 13% by weight of ethyl acetate
Solvent 7: 45% by weight of DMC, 45% by weight of ethyl acetate, and 10% by weight of butyl acetate
Solvent 8: 40% by weight of DMC, 40% by weight of ethyl acetate, and 20% by weight of PMA (propylene glycol monomethyl ether acetate)
Property A: Low-temperature solution stability (If it does not harden after being left at room temperature 5° C. for one day, it was rated as circle; if it hardens, it was rated as cross; and if it partially hardens, it was rated as triangle)
Property B: Suitability for overcoating (If it was easy to overcoat for the skin layer 14, it was rated as circle; if it was difficult to overcoat, it was rated as cross; and if it was not either easy or difficult, it was rated as triangle)
Property C: Application characteristics (for the application of the skin layer 14, if it does not foam or harden, it was rated as circle; if it foams and harden, it was rated as cross; and if it either foams or hardens, it was rated as triangle)
Property D: when the solvent was stirred with the main ingredient, if air was difficult to mix in, it was rated as circle; if air was likely to be mixed in, it was rated as cross, and air partially mixed in, it was rated as triangle.

TABLE 1

| | | | | | Environmental |
|---|---|---|---|---|---|
| | A | B | C | D | impact |
| Solvent 1 (Example) | ◯ | ◯ | ◯ | ◯ | ◯ |
| Solvent 2 (Conventional) | ◯ | ◯ | ◯ | ◯ | X |
| Solvent 3 (Example) | Δ | ◯ | Δ | Δ | ◯ |
| Solvent 4 (Example) | X | ◯ | X | X | ◯ |
| Solvent 5 (Example) | X | ◯ | X | X | ◯ |
| Solvent 6 (Example) | X | ◯ | X | X | ◯ |
| Solvent 7 (Comparative Example) | ◯ | X | X | X | ◯ |
| Solvent 8 (Comparative Example) | Δ | ◯ | X | Δ | ◯ |

As can be seen from Table 1, Solvent 1 had a rating of circle for all properties A to D, and also had a rating of circle for the environmental impact.

Solvent 2 was rated circle for properties A to D, but rated cross for environmental impact.

Solvent 3 was rated triangle in properties A, C, and D, circle in property B, and circle in environmental impact.

Solvents 4 to 6 were rated circle in property B, cross in properties A, C, and D, and circle in environmental impact.

Solvent 7 had a rating of circle for property A, a rating of cross for properties B, C, and D, and a rating of circle for environmental impact.

For Solvent 8, properties A and D were triangle, property B was circle, property C was cross, and environmental impact was circle.

### DESCRIPTION OF REFERENCE NUMERALS

1 Slide fastener
10 Fastener tape
11 Base fabric
12 Water-stop film
13 Adhesive layer
14 Skin layer
2 Fastener stringer
3 Element row
4 Pull
5 Upper stopper
6 Lower stopper

1. A fastener tape, comprising a base fabric (11) having a first surface (10a) and a second surface (11b), and a water-stop film (12) attached to at least one of the first surface (10a) and the second surface (11b) of the base fabric (11), the fastener tape characterized in that:
the water-stop film (12) has a laminated structure consisting of a skin layer (14) consisting of a polyurethane film, and an adhesive layer (13) made of a cured polyurethane adhesive provided between the skin layer (14) and the base fabric (11); and
the polyurethane adhesive is derived from a polyurethane resin dissolved in a solvent containing dimethyl carbonate and propyl acetate.

2. A fastener tape, comprising a base fabric (11) having a first surface (10a) and a second surface (11b), and a water-stop film (12) attached to at least one of the first surface (10a) and the second surface (11b) of the base fabric (11), the fastener tape characterized in that:
the water-stop film (12) has a laminated structure consisting of a skin layer (14) consisting of a polyurethane film, and an adhesive layer (13) made of a cured polyurethane adhesive provided between the skin layer (14) and the base fabric (11); and
the polyurethane adhesive is derived from a polyurethane resin dissolved in a solvent containing dimethyl carbonate, propyl acetate, and butyl acetate.

3. The fastener tape according to claim 1 or 2, wherein the polyurethane adhesive does not contain toluene or methyl ethyl ketone.

4. The fastener tape according to claim 2 or 3, wherein the solvent comprises 24 to 28% by weight of dimethyl carbonate, 59 to 63% by weight of propyl acetate, and 11 to 15% by weight of butyl acetate.

5. The fastener tape according to any one of claims 1 to 4, wherein the solvent vaporizes at a temperature of 90° C. to 110° C.

6. A slide fastener, comprising the fastener tape (10) according to any one of claims 1 to 5.
